(19) United States
(12) Patent Application Publication
(10) Pub. No.: US 2026/0214415 A1
(43) Pub. Date: Jul. 23, 2026

(54) Commercial Equipment Location and Status Tracker

(71) Applicant: Ribbiot, Inc., Huntington Beach, CA (US)

(72) Inventors: Joseph Frigo, Huntington Beach, CA (US); JD Martin, Austin, TX (US); Elliott Chenger, Leander, TX (US); Branden Sheffield, Saratoga Springs, UT (US)

(21) Appl. No.: 19/035,057

(22) Filed: Jan. 23, 2025

(51) Int. Cl. H04W 4/029

(52) U.S. Cl. CPC H04W 4/029

(57) ABSTRACT

A commercial equipment tracker tracking pod provides data via BLE, NFC, UWB, and/or other communications protocols. Such tracking pods periodically communicate advertisement packets to communicate with devices as the tracking pods themselves lack long distance communication equipment to directly connect with server devices over the cloud. Though different tracking devices are associated with different tracking ecosystems, and generally those ecosystems are not compatible, a commercial equipment tracking system can obtain such advertisement packets, determine the identity of the tracking device and/or the tracking service provider of the tracking device, and provide location data to a user of the tracking device regardless of whether the tracking device is a part of the tracking ecosystem.

### FIELD OF TECHNOLOGY

This patent application relates generally to electronic systems and devices, and more specifically to commercial equipment tracking systems and devices.

### BACKGROUND

Commercial assets, such as equipment used on jobsites, are often critical to projects. Due to the expense of various assets, such assets are often shared between jobsites. Accordingly, proper tracking of such assets provides significant logistical advantages, reduces delay, and reduces cost from lost equipment. Nonetheless, for various reasons, organizations may often include trackers from a variety of sources, which complicates logistics.

### SUMMARY

Described are methods and systems for commercial equipment tracking. In a certain embodiment, a commercial equipment tracking system is described.
Clause 1. A commercial equipment tracking system, comprising: a tracking database; and a server device, configured to: receive, from a portal associated with the commercial equipment tracking system, short range tracking data from a third party tracking device, the short range tracking data comprising a publicly available data packet provided by the third party tracking device; provide, based on the receiving the short range tracking data, an API call request to a third party tracking provider; receive an API call response from the third party tracking provider; determine, from the API call response, that the third party tracking device is associated with a first user; update the tracking database based on the API call response; and provide updated tracking data from the tracking database to a user device of the first user.
Clause 2. The commercial equipment tracking system of clause 1, wherein the publicly available data packet comprises an advertisement packet, and wherein the server device is further configured to: determine, from the advertisement packet, that the third party tracking provider is associated with the third party tracking device.
Clause 3. The commercial equipment tracking system of clause 2, wherein the API call request comprises data from the advertisement packet.
Clause 4. The commercial equipment tracking system of clause 1, wherein the advertising packet includes a unique identifier.
Clause 5. The commercial equipment tracking system of clause 4, wherein the third party tracking provider is determined from the unique identifier.
Clause 6. The commercial equipment tracking system of clause 4, wherein the API call response comprises historical location data.
Clause 7. The commercial equipment tracking system of clause 6, wherein the determining that the third party tracking device is associated with the first user is based on the historical location data.
Clause 8. The commercial equipment tracking system of clause 7, wherein the historical location data comprises a plurality of locations that the third party tracking device is detected to be located within.
Clause 9. The commercial equipment tracking system of clause 8, wherein the determining that the third party tracking device is associated with the first user comprises matching the plurality of locations to locations that the unique identifier is detected at.
Clause 10. The commercial equipment tracking system of clause 9, wherein the tracking database stores historical tracking data associated with the unique identifier, and wherein the matching the plurality of locations to locations that the unique identifier is detected at comprises matching the historical location data to historical tracking data of the unique identifier.
Clause 11. A method comprising: receiving, from a portal associated with a commercial equipment tracking system, short range tracking data from a third party tracking device, the short range tracking data comprising a publicly available data packet provided by the third party tracking device; providing, based on the receiving the short range tracking data, an API call request to a third party tracking provider; receiving an API call response from the third party tracking provider; determining, from the API call response, that the third party tracking device is associated with a first user; updating a tracking database based on the API call response; and providing updated tracking data from the tracking database to a user device of the first user.
Clause 12. The method of clause 11, wherein the publicly available data packet comprises an advertisement packet, the method further comprising: determine, from the advertisement packet, that the third party tracking provider is associated with the third party tracking device.
Clause 13. The method of clause 12, wherein the API call request comprises data from the advertisement packet.
Clause 14. The method of clause 11, wherein the advertising packet includes a unique identifier.
Clause 15. The method of clause 14, wherein the third party tracking provider is determined from the unique identifier.
Clause 16. The method of clause 14, wherein the API call response comprises historical location data.
Clause 17. The method of clause 16, wherein the determining that the third party tracking device is associated with the first user is based on the historical location data.
Clause 18. The method of clause 17, wherein the historical location data comprises a plurality of locations that the third party tracking device is detected to be located within.
Clause 19. The method of clause 18, wherein the determining that the third party tracking device is associated with the first user comprises matching the plurality of locations to locations that the unique identifier is detected at.
Clause 20. The method of clause 19, wherein the tracking database stores historical tracking data associated with the unique identifier, and wherein the matching the plurality of locations to locations that the unique identifier is detected at comprises matching the historical location data to historical tracking data of the unique identifier.

These and other examples are described further below with reference to figures.

### BRIEF DESCRIPTION OF THE DRAWINGS

The included drawings are for illustrative purposes and serve only to provide examples of possible structures and operations for the disclosed inventive systems, apparatus, methods, and computer program products for commercial equipment tracking. These drawings in no way limit any changes in form and detail that may be made by one skilled in the art without departing from the spirit and scope of the disclosed implementations.

FIG. 1 illustrates a block diagram of an example system, in accordance with certain embodiments.

FIG. 2 illustrates another block diagram of an example system, in accordance with certain embodiments.

FIGS. 3 and 4 are flowcharts illustrating examples of commercial equipment tracking, in accordance with certain embodiments.

FIG. 5 illustrates an example of commercial equipment tracking, in accordance with certain embodiments.

FIG. 6 illustrates a perspective view of a commercial equipment tracking device, in accordance with certain embodiments.

FIG. 7 illustrates a block diagram of an example computing system, in accordance with certain embodiments.

### DETAILED DESCRIPTION

In the following description, specific details are set forth to provide illustrative examples of the systems and techniques described herein. The presented concepts may be practiced without some, or all, of these specific details. In other instances, well known process operations have not been described in detail to avoid unnecessarily obscuring the described concepts. While some concepts will be described with the specific examples, it will be understood that these examples are not intended to be limiting.

Some implementations of the disclosed systems, apparatus, methods and computer program products are configured for implementing commercial asset tracking systems. The commercial asset tracking systems described herein allow for commercial assets to be tracked by interfacing with user devices and for information related to the assets to be provided via the user devices, according to the techniques described herein. In various embodiments, commercial assets may include, for example, commercial equipment. Such commercial equipment may include heavy equipment (e.g., heavy machinery), tools, light equipment (e.g., handheld equipment), and/or any other such asset that may be helpful for carrying out a project.

Currently, various commercial equipment are tracked by data manually entered by workers, with tracker power and asset information provided through On-Board Diagnostics II (OBD II) ports for vehicles. Accordingly, tracking of commercial equipment is arduous and labor intensive. Tracking via OBD II ports is limited to equipment that includes such ports, such as vehicles. The options for tracking commercial equipment are, thus, limited in both functionality and options. Furthermore, current commercial equipment tracking is limited by specific vendor. That is, each vendor or tracking service provider may provide tracking through their specific implementations and cross compatibility is unavailable.

Described herein are systems and methods for commercial equipment trackers, status trackers, and job readiness platforms. The systems and methods described herein provide an interface that allows companies, such as companies with commercial equipment, to schedule, track, execute, and monitor their daily operations and equipment. The commercial equipment tracker system described herein allows for tracking of the location and status of the commercial equipment, including certain equipment with tracking equipment of different vendors. Thus, the commercial equipment tracker system described herein may receive and provide tracking for trackers that provide signals in a variety of different formats, such as different trackers associated with different tracking models or brands.

The commercial equipment tracker described herein provides a portable digital tracking tag that is configured to be affixed to commercial equipment. The commercial equipment tracker may include sensors, processors, and memories to allow the tracker to obtain information, usage, conditions, and history for the equipment. The tracker may include one or more communications modules that may provide data packets to a mobile device, such as a user's mobile device. The data packets may, for example, provide a unique identifier associated with the tracker or equipment, indicate the location of the tracker, and/or indicate the status of the commercial equipment. An application on the mobile device may then combine the data received from the tracker with data determined by the mobiled device, such as the location information, time, and status data associated with the commercial equipment and relay the data to a server device.

It is appreciated that, for the purposes of this disclosure, when an element includes a plurality of similar elements distinguished by a letter or follow-on numeral following the ordinal indicator (e.g., “116A” and “116B”, “116-1” and “116-2”, or “116A-1” and “116A-2”) and reference is made to only the ordinal indicator itself (e.g., “116”), such a reference is applicable to all the similar elements.

### Tracking System

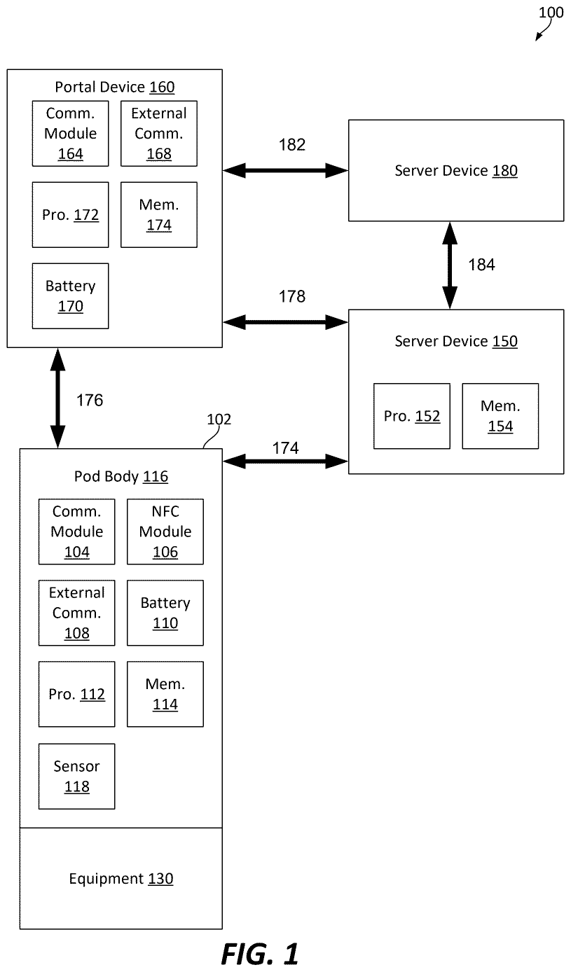

FIG. 1 illustrates a block diagram of an example system, in accordance with certain embodiments. FIG. 1 illustrates system 100 configured to track the location, status, and conditions of commercial equipment, as well as for scheduling usage of the commercial equipment.

System 100 includes tracking pod 102 coupled to commercial equipment 130, portal device 160, server device 150, and server device 180. Various portions of system 100 may be communicatively coupled via any wired and/or wireless data connection, such as via communications channel 174, communications channel 176, communications channel 178, communications channel 182, and communications channel 184. Such communications channels may be, for example, a wired Ethernet connection or a wireless connection such as Bluetooth, Near-Field Communication (NFC), WiFi, 3G, 4G, 5G, or another such connection that allows for data to be transmitted. In various embodiments, the various components of the systems described herein may utilize one, some, or all such data connections to communicate and/or receive the various data described herein.

Tracking pod 102 includes communications module 104, NFC module 106, external communications module 108, battery 110, processor 112, memory 114, and sensor 118. Each of communications module 104, NFC module 106, external communications module 108, battery 110, processor 112, and memory 114 may be disposed within pod body 116.

Communications module 104 may be a short ranged communications module that is configured to connect with a user device, such as portal device 160, to provide data to the user device. Thus, communications module 104 may be, for example, a module configured to communicate via Bluetooth®, Bluetooth Low Energy (BLE), ultra-wideband (UWB), and/or other such communications protocols that allow for devices to communicate data within a range of, for example, 150 meters or less or within a few miles (e.g., via LoRa). In various embodiments, portal device 160 may be a dedicated tracking portal (e.g., configured to receive data from one or more tracking pods 102 and provide tracking data associated with tracking pods 102) and/or may be an electronic device such as a smartphone or wearable device that may function as a tracking portal as well as provide other user functionalities.

In various embodiments, communications module 104 may include one or a plurality of different modules to, for example, allow for communication between tracking pod 102 and portal device 160 via a plurality of different protocols. For example, communications module 104 may include a beacon module, such as a BLE beacon, that allows for portal device 160 to determine the proximity of tracking pod 102 to portal device 160. Accordingly, such a beacon module may allow for portal device 160 to find tracking pod 102 or detect when tracking pod 102 is within a close range (e.g., 150 meters or less) of portal device 160 and provide an alert when tracking pod 102 is within such a range and/or has moved outside of such a range. Beacon module may also allow for determination of the approximate range that tracking pod 102 is away from portal device 160. Thus, such a beacon module, when detected by a plurality of user devices, may allow for triangulation to determine the location of the beacon module and, thus, tracking pod 102. Such triangulation may be performed between the devices themselves and/or may be performed by server device 150 utilizing data received from the various user devices.

In another embodiment, communications module 104 may include a UWB module that communicates through the UWB spectrum to allow for more precise locating of tracking pod 102 by portal device 160. Thus, UWB module allows for accurate location in three-dimensions by portal device 160. In various embodiments, UWB module may provide a shorter range than a BLE beacon, such as a range of 75 meters or less. Accordingly, both a BLE beacon and a UWB module may be utilized in various embodiments of communications module 104.

Such a UWB module may allow for tracking and/or location of equipment within a large jobsite. Certain jobsites may be, for example, up to several square kilometers in size. Equipment may be moved around the jobsite. Thus, for example, a fork lift may be charged in one location and utilized in another location on the jobsite. The UWB module may allow for tracking of the equipment within various portions of the jobsite, simplifying receipt of information, scheduling, and obtaining location details.

Thus, for example, portal device 160 may provide a request for precise tracking of tracking pod 102. The precise tracking may be via the UWB module. Upon receipt of such a request, tracking pod 102 may activate the UWB module and the UWB module may communicate with portal device 160. Precise tracking of tracking pod 102 by portal device 160 may then be accomplished via data from the UWB module.

NFC module 106 may be a module that allows for tracking pod 102 to communicate with portal device 160 via Near-Field communication protocols. In various embodiments, NFC module 106 may allow for tracking pod 102 to easily pair with portal device 160. Thus, for example, tracking pod 102 may simply be disposed proximate (e.g., within a foot) of portal device 160 and pairing data may be communicated between tracking pod 102 and portal device 160 (e.g., data directed to the identity of portal device 160, identity of the item that portal device 160 is associated with, such as the equipment to be tracked, and/or communication information, such as Bluetooth pairing information). Pairing of tracking pod 102 to portal device 160 allows for data to be communicated between tracking pod 102 and portal device 160. NFC module 106 may also allow for tracking pod 102 to communicate data associated with commercial equipment 130 (e.g., data directed to the status of commercial equipment 130) to tracking pod 102 and/or interface with commercial equipment 130 to determine the status, condition, and/or usage of commercial equipment 130.

In certain embodiments, communication module 104 and/or NFC module 106 may, in certain embodiments, allow for portal device 160 to identify commercial equipment 130 by communicatively coupling with NFC module 106. Once communicatively coupled, communication module 104 and/or NFC module 106 may provide information, usage, conditions, history, and/or other data that is associated with commercial equipment 130.

External communications module 108 may be a communication module configured to interface with one or more external devices. Such external devices may include, for example, a global positioning system (GPS) satellite, a cellular tower, or another such device configured to provide data to tracking pod 102. Such an external device may, thus, allow for data to be communicated between tracking pod 102 and server device 150 and/or server device 180 without data being communicated to portal device 160 (e.g., by providing location data for cellular towers to determine the location of tracking pod 102 and provide the determined location to server device 150 and/or server device 180). Alternatively or additionally, external device 160 may provide location data to tracking pod 102 (e.g., GPS data).

Location information may also be deduced from the signal strength of data received by communication module 164 from other devices and/or portal device 160 or another such device may deduce the location of tracking pod 102 from the signal strength of data provided by tracking pod 102. Thus, for example, external device 160 (which may be a user device or a tracking portal configured to communicate with a server device), would utilize the unique identifier of tracking pod 102 (which may be of a BLE format) received by external device 160 and the determined location of external device 160. Utilizing the determined location of external device 160, external device 160 may then utilize the unique identifier of tracking pod 102 and read the Received Signal Strength Indicator (RSSI) from the BLE packet of the unique identifier to determine the strength of the BLE signal from tracking pod 102. Based on the RSSI, external device 160 may estimate the distance of tracking pod 102 away from external device 160.

Accordingly, tracking pod 102 may communicate with external device 160 via communications channel 176 and external device 160 may communicate with server device 150 via communications channel 178 and communicate with server device 180 via communications channel 182. External device 160 may also provide firmware updates or obtain status data automatically from various tracking pods and relay such data to server device 150 and/or server device 180 so that such data may be processed and, if necessary, notifications may be provided to a user (e.g., when certain equipment has moved outside of a zone where the equipment is intended to be within).

Memory 114 may be any type of memory device configured to store data and/or instructions. Memory 114 may be, for example, a harddrive, a solid state device, and/or random access memory (RAM) and may include transitory or non-transitory computer-readable media. Memory 114 may be configured to store instructions for performing the techniques described herein, configured to store commercial equipment data (e.g., data associated with the status of commercial equipment 130), and/or configured to store other such data.

Processor 112 may be a single or multi-core processor. As described herein, processor 112 may be configured to perform various operations as described herein. Accordingly, for example, processor 112 may cause data to be communicated from tracking pod 102 to portal device 160 for tracking of commercial equipment 130. Processor 112 may be any type of single or multi-core processor that allows for electronic data processing. It is appreciated that processor 112 may perform the techniques described herein utilizing one or more databases, modules, and/or other system components as described herein. Accordingly, processor 112 may perform the techniques described herein while calling upon data stored within memory 114 and/or utilizing the data of one or more modules described herein.

Battery 110 may be a battery configured to store electrical power for powering tracking pod 102. Electrical power from battery 110 may be provided to the various components of tracking pod 102 through various electrical circuits. In various embodiments, a state of charge of battery 110 may be determined through various circuit configurations described herein.

Sensor 118 may be, for example, one or more temperature sensors, accelerometers, gyroscopes, strain detectors (e.g., strain gauges), piezoelectric sensors, magnetic sensors, and/or other such sensors. Variously, sensor 118 may be fully contained within pod body 116 and/or may interface (e.g., contact) portions of commercial equipment 130.

In various embodiments, sensor 118 may be configured to, for example, determine ambient environmental conditions and/or movement of tracking pod 102 that is indicative of movement of commercial equipment 130. Thus, for example, sensor 118 may be configured to determine the acceleration, jerk, velocity, and/or vibrations. Sensor 118 may be configured to determine the magnitude and/or frequency of the movement. Sensor data from sensor 118 may be provided to, for example, processor 112 of tracking pod 102.

Processor 112 may accordingly utilize the sensor data to determine various aspects of commercial equipment 130. For example, processor 112 may determine that commercial equipment 130 is being operated and determine the additional operation cycles (e.g., from sensor data indicating the movement or vibration of commercial equipment 130) imparted to commercial equipment 130. Such data may allow for tracking pod 102 to update the number of operation cycles that commercial equipment 130 has been subjected to. Processor 112 may also determine from, for example, acceleration or velocity data the movement of commercial equipment 130 (e.g., from a location where commercial equipment 130 is typically housed within, such as a hanger or a drawer). Such a change in location may be communicated to portal device 160 to provide more accurate information as to the location of commercial equipment 130.

In certain embodiments, input may be provided to tracking pod 102 (e.g., to processor 112 and stored within memory 114) of the type or category of equipment of commercial equipment 130. Based on the type or category of equipment, sensor 118 may be configured to track various aspects of commercial equipment 130. Thus, for example, the user may provide, via portal device 160, that commercial equipment 130 is a tool with a limited amount of cycle life. Accordingly, sensor 118 may be configured to determine movement and/or acceleration of commercial equipment 130 indicative of a load cycle for the tool and, based on the amount of load cycles detected by sensor 118, the status of commercial equipment 130 may be updated. Thus, in various embodiments, data directed to the status of commercial equipment 130 may be stored within memory 114, may be provided to portal device 160 and stored within memory 174 of portal device 160 and/or communicated to server device 150 and/or server device 180 for storage. Based on the data from sensor 118, such stored data may be accordingly updated and, thus the status of commercial equipment 130 may be updated.

In another such embodiment, data from sensor 118 may indicate when commercial equipment 130 is being operated and, based on such a determination, the operational hours of commercial equipment 130 may be tracked. In a further such embodiment, data from sensor 118 may indicate that commercial equipment 130 is being utilized or located in the area of operation of various operators and, accordingly, the operators that have used the specific commercial equipment 130 may also be updated. Furthermore embodiments may, for example, detect the environmental conditions, such as temperature and pressure (e.g., via temperature or pressure sensors), that commercial equipment 130 has been subjected to. Thus, if commercial equipment 130 has been subjected to temperatures beyond its operating envelope, the status of commercial equipment 130 may be changed to “non-operational.”

Pod body 116 may be, for example, any type of external body that can be configured to contain the components of tracking pod 102 and allow for tracking pod 102 to be held by a user. Thus, pod body 116 may be a case for the components of tracking pod 102 that is made from plastic, composites, metal, rubber, and/or other materials.

Pod body 116 may be configured to be disposed within housing 120. Accordingly, housing 120 may include a cavity that may be shaped to receive pod body 116. Pod body 116 may, in certain embodiments, be configured to be snugly held within the cavity of housing 120. Housing 120 may be a housing made from plastic, composites, metal, rubber, and/or other materials and may provide a durable outer covering for tracking pod 102 to prevent damage to tracking pod 102 (e.g., from operation of various commercial equipment around tracking pod 102).

Commercial equipment 130 may be any type of commercial equipment, including handheld equipment such as tools and bits, heavy equipment such as vehicles, raw materials, and/or other such commercial equipment. In various embodiments, commercial equipment 130 may be shared equipment, such as equipment shared within a company or firm, or rental equipment. Commercial equipment 130 may be shared between different jobs and/or sites and may be moved between those jobs and/or sites depending on project need.

Portal device 160 may be an electronic device configured to receive data from tracking pod 102. In various embodiments, portal device 160 may be an electronic device specifically configured to receive data from tracking pod 102 (e.g., an electronic device configured to receive tracking data from tracking pod 102) and/or may be a user device, desktop computing devices, portable computing devices (e.g., laptops, tablets, smartphones, and/or other electronic devices), wearable devices, and/or other such electronic devices. Portal device 160 may be configured to utilize tracking pod 102 to track the location and/or status of commercial equipment 130.

Portal device 160 may include communications module 164, external communications module 168, battery 170, processor 172, and memory 174. Communications module 164 may be a short ranged communications module, similar to communications module 104, configured to connect with an associated device, such as tracking pod 102, and communicate (e.g., send or receive) data from such devices. External communications module 168 may be a communication module configured to interface with one or more external devices through long range communications. Such external devices may include, for example, a global positioning system (GPS) satellite, a cellular tower, or another such device configured to provide or receive data from portal device 160. External communications module 168 may be configured to allow for portal device 160 to communicate with other devices, such as server device 150 and/or server device 180, via communications channel 178 and/or communications channel 180, respectively.

Processor 172 and memory 174 may be similar to other processor and/or memory described herein. Thus, memory 174 may store instructions and processor 172 may be configured to perform techniques described herein based on instructions stored within memory 174. Battery 170 may be a battery configured to store energy to operate portal device 160.

Data, such as tracking data, may be communicated between tracking pod 102 and portal device 160 via communications channel 176. Communications channel 176 may be a communications channel utilizing any of the communications standards described herein. In various embodiments, a plurality of portal devices may be communicatively coupled to tracking pod 102 and each portal device may be configured to track the location of tracking pod 102 if the portal device is within range of tracking pod 102.

In various embodiments, portal device 160 may be configured to scan tracking pod 102 and determine details of the equipment that tracking pod 102 is coupled to. For example, portal device 160 may scan tracking pod 102 to determine the maintenance that is due to be performed on equipment 130. Once maintenance has been performed, portal device 160 may also scan tracking pod 102 to indicate that the maintenance has been performed. Such a technique may reduce paper trail requirements.

Server device 150 and/or server device 180 may be a server system that operates as one computing device or a plurality of devices. Each of server device 150 and/or server device 180 may be, for example, an application server, a database server, a client system such as a laptop, desktop, smartphone, tablet, wearable device, set top box, etc., or any other device or service described herein.

Server device 150 may include processor 152 and memory 154 and server device 180 may include similar componentry. Memory 154 may include one or more databases that may provide data to portal device 160 via communications channel 178 (e.g., in response to requests for data from portal device 160) for server device 178 and via communications channel 182 for server device 180. Processor 152 may be configured to perform operations of server device 150, as described herein. In certain embodiments, server device 150 and server device 180 may communicate data via communications channel 184. Such communications may provide for implementation of certain portions of the techniques described herein.

Additionally or alternatively, server device 150 may receive data (e.g., location data) from tracking pod 102 and/or provide data (e.g., instructions) to tracking pod 102 via communications channel 174. Server device 150 may also provide data to portal device 160 to, for example, allow for scheduling of commercial equipment 130 (e.g., to be used by various users of commercial equipment 130, such as between different jobsites). In certain such embodiments, communications channel 174 may be a communications channel providing data through, for example, a cellular network.

### Network System

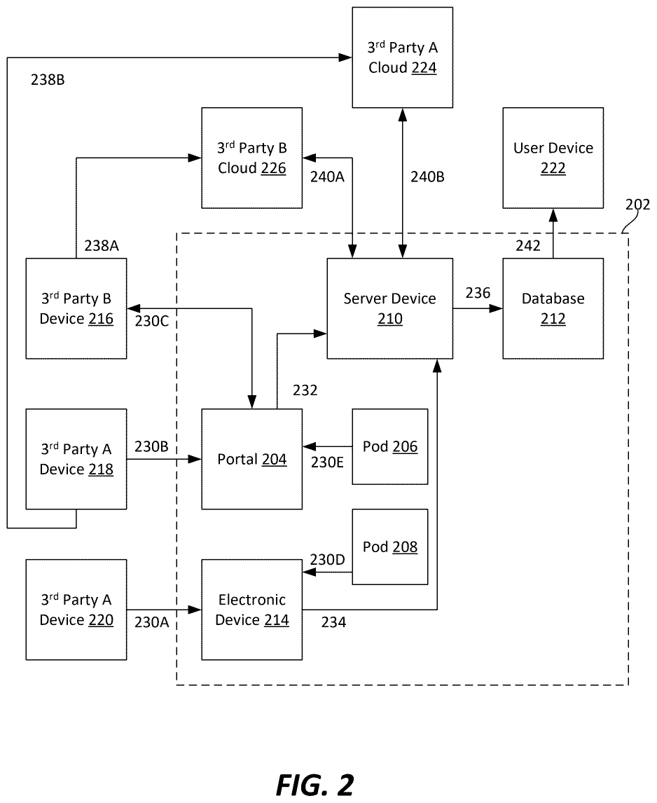

FIG. 2 illustrates another block diagram of an example system, in accordance with certain embodiments. FIG. 2 illustrates a system that includes tracking ecosystem 202, user device 222, 3^{rd} party A device 218 and 3^{rd} party A device 220, 3^{rd} party B device 216, 3^{rd} party cloud 224, and 3^{rd} party cloud 226. Various communications channels (e.g., communications channels 230, 232, 234, 236, 238, and/or 240) may communicatively couple the various portions of the system. As shown and described in FIG. 2, communications channels 230, 232, 234, 236, 238, and/or 240 may be any wired and/or wireless long and/or short ranged communications channels configured for communicating data.

Tracking ecosystem 202 may include portal 204, electronic device 214, server device 210, and database 212. In various embodiments, portal 204 may be a portal configured to receive data, such as location or tracking data, from various devices or tracking pods described herein. Portal 204 may be configured to receive such data from pod 260 and/or pod 208 and provide such data, or portions thereof, to server device 210. Thus, portal 204 may be configured to interface with various pods described herein.

Electronic device 214 may be, in certain embodiments, an electronic device associated with a party, such as a party that is renting equipment, and/or another such electronic device. In certain embodiments, electronic device 214 may include apps or computer programs that are associated with tracking ecosystem 202. That is, electronic device 214 may include one or more apps or computer programs that receive tracking data, determine that such tracking data is associated with tracking ecosystem 202, and provide such tracking data to server device 210.

Server device 210 may, in certain embodiments, be similar to server device 150. Server device 210 may be a part of tracking ecosystem 202 and be configured to receive and communicate data to various pods, portals, and/or electronic devices (e.g., pod 206 and/or pod 208, electronic device 214, and/or portal 204) as well as other server devices (“3^{rd} party servers”), such as 3^{rd} party cloud 224 and 3^{rd} party cloud 226. Server device 210 may receive such data and, based on the data received, provide tracking data to user device 222. In certain embodiments, such data may be communicated from server device 210 to database 212. Database 212 may then store and/or organize such data within the memory of database 212. Data stored within database 212 may be accessed and provided to user device 222.

In certain embodiments, database 212 may store data associated with a plurality of different users, user devices, 3^{rd} parties, and/or other parties. Database 212 may securely store such data to prevent, for example, a 2^{nd} user from accessing the data of the 1^{st} user. Furthermore, in certain embodiments, the data of each individual 3^{rd} party is separated from that of other 3^{rd} parties, to provide for data security. Alternatively, data of each 3^{rd} party may be stored in physically separate databases to increase data security.

FIG. 2 may further include 3^{rd} party devices, including 3^{rd} party devices associated with different third parties. For example, FIG. 2 illustrates 3^{rd} party devices associated with 3^{rd} party A (3^{rd} party A device 218 and 3^{rd} party A device 220) and 3^{rd} party devices associated with 3^{rd} party B (3^{rd} party B device 216). Various other embodiments may include other or additional devices associated with various 3^{rd} parties, including other 3^{rd} parties.

3^{rd} party A cloud 224 and/or 3^{rd} party B cloud 226 may include one or more computers, servers, and/or other electronic devices associated with 3^{rd} party A and 3^{rd} party B, respectively. Such devices may receive tracking data, determine the user, item, and/or location associated with such tracking data, and curate the data to provide for tracking of the devices associated with the tracking data. In various embodiments, 3^{rd} party A cloud 224 and/or 3^{rd} party B cloud 226 may provide such data to another party upon request, such as via an Application Programming Interface (API) call.

3^{rd} party A device 218 and 3^{rd} party A device 220 may be associated with a first 3^{rd} party. Such devices may, for example, provide tracking data associated with one or more items (e.g., equipment) associated with 3^{rd} party A. Thus, such devices may be one or more of purpose-built trackers, associated electronic devices (e.g., smartphones, tablets, wearable devices, and/or other such devices), and/or other such devices that may generate, provide, and/or forward tracking data.

In certain embodiments, 3^{rd} party A device 218 and 3^{rd} party A device 220 may provide tracking data to one or more of 3^{rd} party A cloud 224, portal 204, and/or electronic device 214. Tracking data provided to 3^{rd} party A cloud 224 may be received by 3^{rd} party A cloud 224 and processed and/or stored as appropriate. Such data may be provided to another party (e.g., the operator of tracking ecosystem 202) upon request, such as via an API call.

In certain embodiments, tracking ecosystem 202 may be associated with a specific group of trackers (e.g., a specific service provider, tracker brand, type of tracker, and/or other such ecosystem). Thus, tracking ecosystem 202 may be configured to receive tracking data from pods within tracking ecosystem 202 and provide such tracking data to a user (e.g., the user of user device 222).

According to the systems and techniques described herein, tracking ecosystem 202 may provide tracking data for various 3^{rd} party devices to the user (e.g., the user of user device 222). Typically, tracking data pertaining to one tracking ecosystem are not discernable to other (e.g., 3^{rd} party) tracking ecosystems. Thus, trackers are “locked in” to a specific tracking ecosystem. As such, an organization that utilizes trackers from a plurality of different providers are required to track their equipment through a plurality of different tracking systems (e.g., different apps and/or software packages), leading to great inconvenience for such organizations.

The systems and techniques described herein allow for tracking ecosystem 202 to provide tracking data associated with tracking devices of 3^{rd} parties. Accordingly, tracking ecosystem 202 may obtain tracking data from other ecosystems and provide tracking information from such ecosystems to the user. In certain such embodiments, such information may be provided alongside tracking information of tracking ecosystem 202 (e.g., integrated within a GUI provided by user device 222).

In certain embodiments, portal 204 may determine that a 3^{rd} party device, such as 3^{rd} party A device 218 and/or 3^{rd} party B device 216, is disposed proximate portal 204. Such a determination may be via, for example, portal 204 detecting short range communications data provided by 3^{rd} party A device 218 and/or 3^{rd} party B device 216 (e.g., Bluetooth data). In certain such communications protocols, such as Bluetooth protocols (e.g., via the Bluetooth advertisement packet transmitted for pairing devices through the Bluetooth standard), each device may transmit a unique identifier. Portal 204 may receive tracking data from the various devices, including the unique identifiers, and provide such data to server device 210.

Server device 210 may receive such data from portal 204 and parse the tracking data. In certain embodiments, the unique identifiers are arranged in a certain manner to provide information for a specific device. For example, the unique identifiers may identify the brand of tracker, the model of tracker, the serial number of the specific tracker, and/or other such information. Server device 210 may receive such tracking data and parse such data to determine such aspects and/or may reference the various 3^{rd} party clouds (e.g., 3^{rd} party A cloud 224 and/or 3^{rd} party B cloud 226) to determine such information.

In certain embodiments, the unique identifiers may identify or include certain patterns that allow for identification of certain aspects of the 3^{rd} party device (e.g., the specific 3^{rd} party that provides tracking for the 3^{rd} party device, the user of the 3^{rd} party tracking device, the device ID, the make and model of the device, the equipment that the device is tracking, and/or other such aspects). In certain such embodiments, unique identifiers for devices associated with a specific 3^{rd} party (e.g., 3^{rd} party A or 3^{rd} party B), may include certain indicator sections (e.g., data bits) and/or patterns that allow for the identification of the specific 3^{rd} party. Server device 210 may be configured to determine such indicator sections and/or patterns and, accordingly, determine the 3^{rd} party that is likely associated with the specific device. Based on such a determination, server device 210 may provide an API call to the appropriate 3^{rd} party cloud (e.g., if server device 210 determines that the specific device is associated with 3^{rd} party A, it may provide an API call to 3^{rd} party A cloud 224 while, if server device 210 determines that the specific device is associated with 3^{rd} party B, it may provide an API call to 3^{rd} party B cloud 226).

The specific 3^{rd} party may then provide a reply to the API call. The reply may allow for server device 210 to determine various tracking aspects of the specific device. For example, the reply may allow server device 210 to confirm the association between the specific 3^{rd} party and the specific device and/or the equipment that the specific device is configured to track. Additionally or alternatively, the reply may provide the last location of the specific device tracked by the specific 3^{rd} party. In various situations, such a location may or may not match the location that server device 210 has received tracking data from that is provided by the specific device, but would still allow for a determination of whether the equipment is being appropriately tracked. Techniques for various such determination for further described herein.

Additionally or alternatively, server device 210 may, upon receiving data from one of the various third party devices and/or determining the location thereof, server device 210 may determine the 3^{rd} party that the device is associated with and provide data from the tracking device and/or data indicating that the tracking device was detected in a certain location to such a 3^{rd} party. In certain embodiments, such data may indicate, for example, that a device with the device ID of the tracking device detected has been detected in the location.

### Tracking Techniques

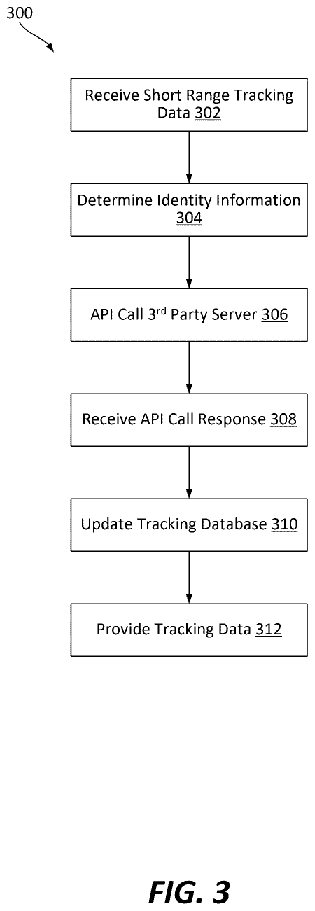

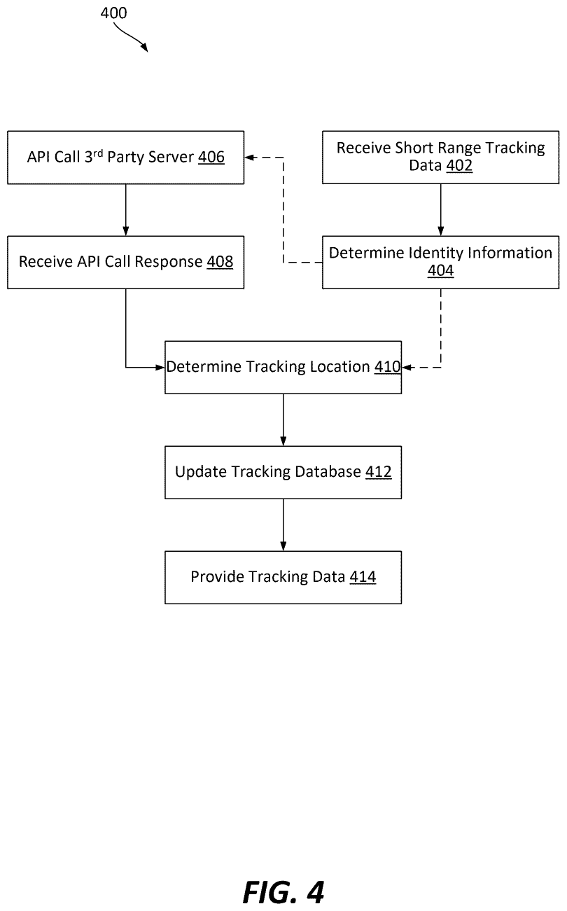

FIGS. 3 and 4 are flowcharts illustrating examples of commercial equipment tracking, in accordance with certain embodiments.

FIG. 3 illustrates technique 300, which may be a technique for a tracking ecosystem to provide tracking data for devices within other tracking ecosystems. In certain embodiments, technique 300 may provide a user with tracking information from a plurality of tracking ecosystems. Technique 300 may be performed by the systems of a specific tracking ecosystem, such as tracking ecosystem 202 of FIG. 2.

Technique 300 may provide tracking information for at least devices that are within short range communication range of one or more devices and/or portals of the tracking ecosystem. In 302, short range tracking data may be received from one or more tracking pods. Such tracking pods may be tracking pods associated with the specific tracking ecosystem (e.g., tracking ecosystem 202) or may be tracking pods not associated with the specific tracking ecosystem. The short range tracking data may be data in any format described herein, such as Bluetooth data or other appropriate data.

In certain embodiments of short range tracking, as part of the data transmission, the data transmitted by each tracking pod may include a unique identifier. For example, Bluetooth communication protocols may include a specific unique identifier as a portion of the data transmission (e.g., during initial data connection). The unique identifier may include information that is unique for the specific device. For example, the unique identifiers may identify the brand of tracker, the model of tracker, the serial number of the specific tracker, and/or other such information.

In 304, the short range tracking data received in 302 may be parsed. Parsing of the short range tracking data may allow for determination of various aspects of the tracking pods, such as the identity of the specific device, the equipment associated with the tracking pod, the tracking service provider (e.g., the service provider for tracking ecosystem 202 or a 3^{rd} party, such as 3^{rd} party A or 3^{rd} party B). Such determination may be through the unique identifier that may be determined by the parsing.

As described herein, the unique identifier may include portions that allow for determination of such information. In certain embodiments, the short range tracking data may include indicators calling out the unique identifier and the portions of the unique identifier denoting the various categories of information described herein, may include a separate transmission of the unique identifier, and/or the unique identifier may be integrated within a data string without indicators and the processing that performs the parsing may be configured to identify the unique identifier within the data string.

For example, the short range tracking data may include a service Universally Unique Identifier (UUID) that is a 128-bit unique identifier indicating the services that the tracking device may support. The UUID may include a signature indicating the type of communications protocol that is supported (e.g., BLE protocol). The UUID may also include data (e.g., through a data hash) indicating the service provided (e.g., tracking) and/or the service vendor that is associated with the device. The UUID may also include in, for example, the advertising data information indicating the hardware type and/or version and/or firmware version that the tracking device is running. Such data may be provided in, for example, a hex string of the advertising data.

Thus, in certain embodiments, a server device or database may, through historical data (e.g., stored within a database), determine that the unique identifier is located in certain portions of the short range tracking data. Additionally or alternatively, the server device may, through historical data (e.g., stored within a database), determine that certain patterns of the unique identifier data corresponds to specific devices, equipment, tracking service providers, and/or other identities. Thus, the server device may determine identity information from the short range tracking data received.

In 306, the server device may provide an API call to a 3^{rd} party server. The server device may determine the 3^{rd} party that is provided the API call via data indicating the tracking service provider or other information. In certain embodiments, though the unique identifier may not explicitly call out tracking service provider (e.g., the 3^{rd} party), specific patterns within the unique identifier may allow for the server device to determine the tracking service provider (e.g., in 304). Thus, in certain embodiments, the database or server device may include historical information that indicates the unique identifier format and/or specific data within the unique identifier that allows for the determination of the identity of the 3^{rd} party to be provided the API call.

The API call may include data identifying the tracker and/or equipment (e.g., may include the unique identifier). Additionally, the API call may include requests for information that is associated with the tracker and/or equipment. Thus, for example, the API call may include requests for the status of the tracker (e.g., operational, disconnected, inoperable, or another status), the last known location of the tracker, the equipment associated with the tracker, and the user of the tracker, and/or other such information.

In certain situations, the tracking ecosystem (e.g., the server device of the tracking ecosystem) may not identify a single 3^{rd} party tracking provider for the tracking device. Instead, the server device may determine that the tracking device may be associated with one of a plurality of different 3^{rd} parties or may be unable to determine the 3^{rd} party that is providing tracking. In such a situation, the tracking ecosystem or a server device herein may provide an API call to the plurality of tracking providers or a list of tracking providers to see whether any of the tracking providers provides a confirmation of their providing tracking for the tracking device.

In 308, a response to the API call may be received. The response may provide the information requested in the API call of 306 or may provide a different response. For example, in certain embodiments, the API call may request the last known location of the tracker, the equipment associated with the tracker, and the user of the tracker, and/or other such information and the response may provide such data. In other embodiments, the response may indicate that certain requested data may be unavailable or unable to be provided (e.g., that the tracker is not associated with the specific 3^{rd} party). Additionally or alternatively, responses to the API call may include additional or alternative information.

In 310, based on the data received from the response, the tracking database may be updated. The tracking database may store the data provided in the API call response. In certain embodiments, the tracking database may be updated to reflect additional data received that is associated with, for example, the status of the tracker, the last known location of the tracker, the equipment associated with the tracker, and the user of the tracker, and/or other such data elements.

The updated tracking data may be provided to a user in 312. The updated tracking data may be provided to a user device (e.g., user device 222). The updated tracking data may include the data received in the API call response, as well as other API call responses received from other parties. Thus, the tracking ecosystem (e.g., tracking ecosystem 202) may provide tracking data of trackers that are associated with other 3^{rd} parties in addition to trackers of the tracking ecosystem itself.

Additionally or alternatively, the updated tracking data may include additional information determined by the tracking ecosystem (e.g., tracking ecosystem 202). For example, based on the data of the API call response, the server device may determine additional information related to the trackers of the 3^{rd} party devices. Determination of such additional information may be further described herein, such as in FIG. 4.

FIG. 4 illustrates technique 400, which may be a technique for a tracking ecosystem to receive tracking data for devices within other tracking ecosystems and provide tracking data based on the data received. Technique 400 may illustrate a technique where a server device of a tracking ecosystem receives short range tracking data from a 3^{rd} party device.

In 402, a portion of the tracking ecosystem (e.g., a portal) may receive short range tracking data from a 3^{rd} party device, such as a 3^{rd} party tracker. The short range tracking data may be tracking data of a certain communications protocol. In certain embodiments, certain 3^{rd} party devices may periodically ping data (e.g., publicly available data packets that may be received by other devices, such as an advertisement packet to pair with another device and/or to determine whether there are devices within communication range that may be paired). The pinged data (e.g., the advertisement packet) may include certain data described herein, such as identifying data that may include, in certain embodiments, the unique identifier described herein.

Thus, for example, in certain embodiments utilizing certain communications protocols, such as with Bluetooth communications protocols, pairing data may be periodically transmitted and the transmission of such data may include data that identifies the tracking device, the 3^{rd} party, the equipment, and/or other such information. In various embodiments, the portal of the tracking ecosystem may receive such data as the pings are publicly receivable, even though the portal may be associated with a different tracking ecosystem than that of the 3^{rd} party tracking device.

Based on such data, the portal and/or a server device that the portal communicates data with (e.g., a part of the tracking ecosystem), may determine identity information from the short range tracking data received in 402. Thus, the received short range tracking data may be parsed according to the techniques described herein. For example, the unique identifier portion of the data (e.g., advertisement packet) may be determined from within the data received.

Based on the unique identifier, portions of the tracking ecosystem (e.g., the portal and/or the server device) may determine information that identifies the tracking device, the 3^{rd} party, the equipment, and/or other such information. Such determination may be via techniques described herein, including determinations directly from the data (e.g., the short range tracking data may include data that directly provides such information) and/or indirectly from the data (e.g., the portal and/or server device may infer from the data, e.g., via arrangement of data strings, that the data indicates certain information, such as device ID number and/or the identity of the 3^{rd} party via, for example, historical trends of such data provided). Thus, identity information may be determined in 404.

In certain embodiments, once identity information is determined, the location of the tracking device may be determined (e.g., via location data provided as a part of the short range tracking data from the tracking device and/or from the location of the portal that receives the data) in 410.

Alternatively, based on the identity information, the tracking ecosystem may determine the identity of the 3^{rd} party associated with the tracking device and provide an API call to a server device of the 3^{rd} party in 406. The API call may request certain information from the 3^{rd} party server, such as the device identification information of one, some, or all tracking devices associated with the 3^{rd} party (e.g., including or excluding the tracking device that provided the short range tracking data in 402), the last known location of one, some, or all such tracking devices, the type of device for such devices, the associated equipment, the user of the trackers, confirmation of the 3^{rd} party identity, and/or other such information. Generally, any information relevant to tracking provided by the identified 3^{rd} party may be requested with the API call.

The 3^{rd} party server may respond to the API call in 408. The response may be communicated to a portion of the tracking ecosystem, such as a server device. The response may include none, some, or all of the data requested by the API call, as well as additional data. Such additional data may include, for example, data for trackers that are not requested in the API call, data indicating that trackers may be shared between different entities, and/or other such data.

In certain embodiments, the API call response may be provided to the identified user of the tracking device that data is received from in 402. Thus, the user may receive data from the various 3^{rd} parties, receive the API call, and provide an API call response in accordance with the API call. Certain such configurations may, thus, allow for a user to positively identify all devices associated with the user, whether affirmatively tracked by the tracking ecosystem or not. From such data, the tracking ecosystem and/or the server device may then parse data received from its various portals and other devices and match the data to the identified devices. Thus, for example, the tracking ecosystem and/or server device may determine that a specific device has previous locations that matches that of a detected device and determine that the detected device, and its unique identifier, matches that of that specific device. Additionally or alternatively, the tracking ecosystem and/or server device may receive an API call response with unique identifiers of various devices and such unique identifiers may be matched to data received (e.g., from various advertisement packets with unique identifiers) to match such devices, the user, and/or the equipment that is being tracked, with the specific tracking device.

Therefore, additional or alternative to the tracking location determined from the short range tracking data received, the tracking ecosystem (e.g., a server device of the tracking ecosystem) may receive the data from the API call response in 410. In certain embodiments, the API call response may include the last known location of the tracking device of 402, as well as the last known location of the other tracking devices.

Thus, for example, though the tracking ecosystem or a server device herein may not positively identify a specific tracking device, the tracking ecosystem or a server device herein may correlate data provided by the API call response of a 3^{rd} party to constructively identify such a device. For example, based on API call responses provided by a 3^{rd} party, a certain specific device may be identified at a first location, a second location, and a third location. The tracking ecosystem may determine that a single tracking device with a specific unique identifier has been detected at the first location, the second location, and the third location during those times (e.g., advertisement packet data for such a device may be determined). Accordingly, the tracking ecosystem or the server device herein may determine that the data detected (e.g., advertisement packet data) may correspond to the specific device in the API call response, which was not previously identified.

In certain embodiments, the server device may determine whether the last known location of the tracking device matches that of the locations detected (e.g., by the devices of the tracking ecosystem). If the last known location does not match, the server device may determine whether the currently detected location would make sense in light of the information provided by the 3^{rd} party server.

For example, the 3rd party server may indicate a different last known location detected 3 days ago, and the server device may determine that the difference between the last known location and the currently detected location is feasible for equipment to travel between in 3 days. Alternatively, the 3^{rd} party server may indicate a different last known location where the time period may not be feasible to travel between, in light of the equipment that the tracking device is coupled to (e.g., heavy equipment may not travel long distances in a day). Based on the determination that the detected location is unfeasible, the server device may determine that the detected location is a false positive or may nonetheless determine that the detected location is correct. Furthermore, the 3^{rd} party server may indicate a different last known location, but also a schedule of travel for the equipment. The server device may confirm that the detected location corresponds to the server travel.

In 412, the tracking database may be updated based on the data provided in the API call response, as well as the detected location and the confirmation determined by the server device. The update may, thus, allow for the tracking database to include tracking data corresponding to tracking devices of 3^{rd} party trackers that are not associated with the tracking ecosystem. That is, the tracking ecosystem may not perform direct tracking of such tracking devices through normal techniques as those trackers are not compatible with the tracking ecosystem. Instead, such tracking devices are detected through “sniffing” of short range tracking data emitted by the tracking device, such as advertisement packet data provided by the tracking device.

In 414, the tracking data of the database may be provided to a user of the tracking ecosystem. The user may include tracking devices that are both associated with the tracking ecosystem, as well as other 3^{rd} party trackers. Due to the system and techniques described herein, the tracking ecosystem may provide tracking data for both devices that are a part of the tracking ecosystem as well as devices that are tracked by 3^{rd} party services. Accordingly, the system and techniques described herein allow for a user to receive tracking data for some or all of their equipment trackers within the same GUI, regardless of whether a plurality of different tracking ecosystems are utilized.

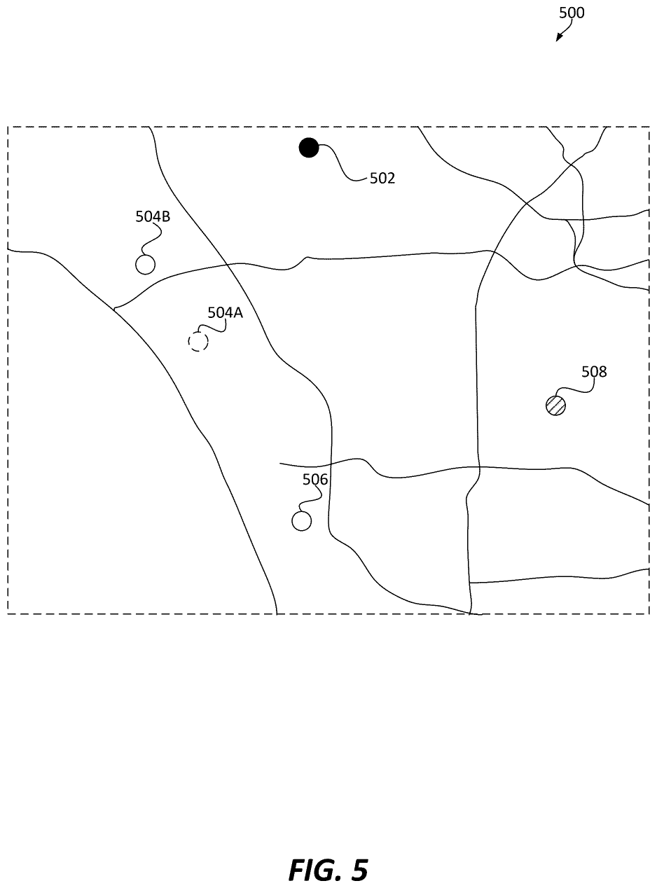

FIG. 5 illustrates an example of commercial equipment tracking, in accordance with certain embodiments. FIG. 5 illustrates GUI 500, which is a GUI illustrating the various locations of trackers that are associated with a user. Based on the determined locations of the trackers, the equipment associated with each tracker may also be tracked.

For example, GUI 500 may include elements 502, 504A, 504B, 506, and 508. Element 502 may indicate a location of a first tracking device. The location of the first tracking device associated with element 502 may be provided to the tracking ecosystem as part of an API call. Element 502 may then be accordingly communicated to the user device for display on a GUI, according to the systems and techniques described herein.

Element 504A may be the last known location of a second tracking device provided as part of a response to the API call. The API call may further indicate that the last known location was detected three days ago. However, the tracking ecosystem may detect the second tracking device at the location associated with element 504B within the last day. Based on an analysis of the equipment and the distance, the server device may determine that the second tracking device moving to the location of element 504B is feasible.

Element 506 may be the location of a third tracking device. The tracking ecosystem may detect the presence of the third tracking device at the location of element 506 and determine, from the data received (e.g., within the periodic ping provided by the third tracking device) that the third tracking device is associated with a 3^{rd} party. An API call may be communicated to the 3^{rd} party (e.g., a call requesting confirmation of the ownership and tracking service provider for the third tracking device, as well as information for associated equipment, last known location, and/or other such information). The API call response may confirm that the third tracking device is associated with the 3^{rd} party, but may not provide a last known location. Accordingly, the tracking ecosystem may confirm that the third tracking system is associated with the 3^{rd} party and provide the detected location of element 506 to the user. Alternatively, the API call response may provide location data for a plurality of different locations and indicate that a tracking device with the unique identifier was detected at each of the different locations, in certain timeframes.

Element 508 may be a location of a fourth tracking device detected by the tracking ecosystem. The location of the fourth tracking device may be confirmed through the API call response (e.g., the last known location for the fourth tracking device of the API response may match the detected location). Accordingly, the GUI may provide the location of the fourth tracking device as element 508 and may, in certain embodiments, indicate that the location is of high confidence.

### Device Example

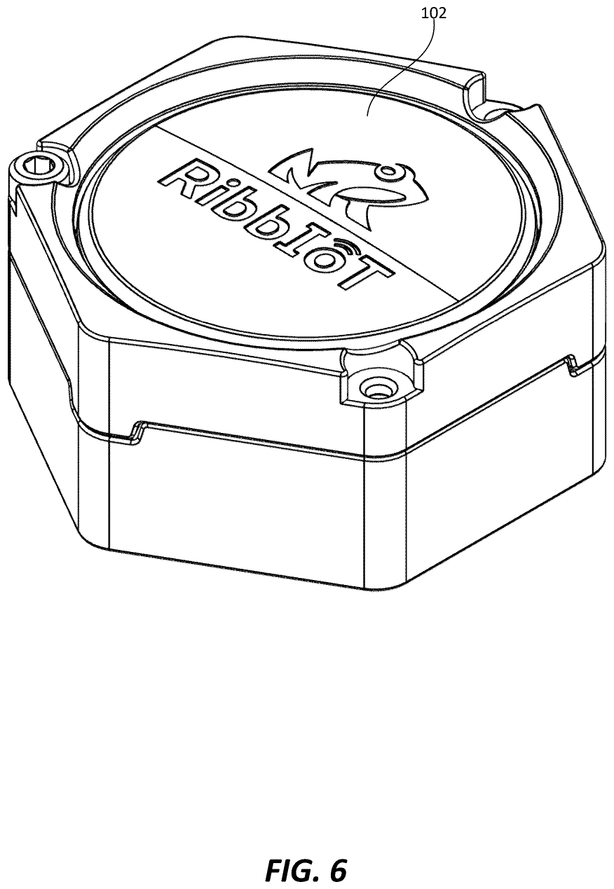

FIG. 6 illustrates a perspective view of a commercial equipment tracking device, in accordance with certain embodiments. As shown in FIG. 6, tracking pod 102 may be disposed within housing 120. Tracking pod 102 may be a tracking pod as described herein. Housing 120 may be configured to couple to certain commercial equipment. In various embodiments, housing 120 may be configured to couple to the commercial equipment via one or more different techniques, such as through bolting, screwing, welding, adhesives, and/or other such techniques. As such, housing 120 may be securely coupled to commercial equipment and may minimally move when coupled to commercial equipment.

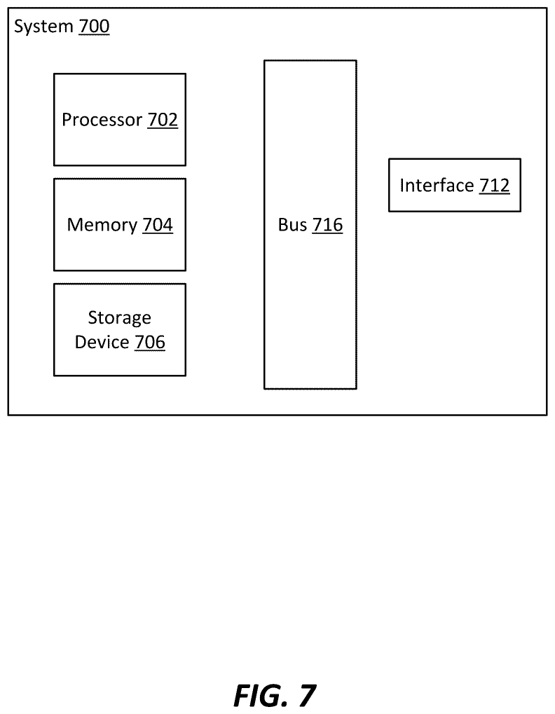

FIG. 7 illustrates a block diagram of an example computing system, in accordance with certain embodiments. According to various embodiments, a system 700 suitable for implementing embodiments described herein includes a processor 702, a memory module 704, a storage device 706, an interface 712, and a bus 716 (e.g., a PCI bus or other interconnection fabric.) System 700 may operate as variety of devices such as a server system such as an application server and a database server, a client system such as a laptop, desktop, smartphone, tablet, wearable device, set top box, etc., or any other device or service described herein.

Although a particular configuration is described, a variety of alternative configurations are possible. The processor 702 may perform operations such as those described herein. Instructions for performing such operations may be embodied in the memory 704, on one or more non-transitory computer readable media, or on some other storage device. Various specially configured devices can also be used in place of or in addition to the processor 702. The interface 712 may be configured to send and receive data packets over a network. Examples of supported interfaces include, but are not limited to:
Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed embodiments may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

### CONCLUSION

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various embodiments have been described herein, it should be understood that they have been presented by way of example only, and not limitation. For example, some techniques and mechanisms are described herein in the context of fulfillment. However, the disclosed techniques apply to a wide variety of circumstances. Particular embodiments may be implemented without some or all of the specific details described herein. In other instances, well known process operations have not been described in detail in order not to unnecessarily obscure the techniques disclosed herein. Accordingly, the breadth and scope of the present application should not be limited by any of the embodiments described herein, but should be defined only in accordance with the claims and their equivalents.

1. A commercial equipment tracking system, comprising:
a tracking database; and
a server device, configured to:
receive, from a portal associated with the commercial equipment tracking system, short range tracking data from a third party tracking device, the short range tracking data comprising a publicly available data packet provided by the third party tracking device;
provide, based on the receiving the short range tracking data, an API call request to a third party tracking provider;
receive an API call response from the third party tracking provider;
determine, from the API call response, that the third party tracking device is associated with a first user;
update the tracking database based on the API call response; and
provide updated tracking data from the tracking database to a user device of the first user.

2. The commercial equipment tracking system of claim 1, wherein the publicly available data packet comprises an advertisement packet, and wherein the server device is further configured to:
determine, from the advertisement packet, that the third party tracking provider is associated with the third party tracking device.

3. The commercial equipment tracking system of claim 2, wherein the API call request comprises data from the advertisement packet.

4. The commercial equipment tracking system of claim 1, wherein the advertising packet includes a unique identifier.

5. The commercial equipment tracking system of claim 4, wherein the third party tracking provider is determined from the unique identifier.

6. The commercial equipment tracking system of claim 4, wherein the API call response comprises historical location data.

7. The commercial equipment tracking system of claim 6, wherein the determining that the third party tracking device is associated with the first user is based on the historical location data.

8. The commercial equipment tracking system of claim 7, wherein the historical location data comprises a plurality of locations that the third party tracking device is detected to be located within.

9. The commercial equipment tracking system of claim 8, wherein the determining that the third party tracking device is associated with the first user comprises matching the plurality of locations to locations that the unique identifier is detected at.

10. The commercial equipment tracking system of claim 9, wherein the tracking database stores historical tracking data associated with the unique identifier, and wherein the matching the plurality of locations to locations that the unique identifier is detected at comprises matching the historical location data to historical tracking data of the unique identifier.

11. A method comprising:
receiving, from a portal associated with a commercial equipment tracking system, short range tracking data from a third party tracking device, the short range tracking data comprising a publicly available data packet provided by the third party tracking device;
providing, based on the receiving the short range tracking data, an API call request to a third party tracking provider;
receiving an API call response from the third party tracking provider;
determining, from the API call response, that the third party tracking device is associated with a first user;
updating a tracking database based on the API call response; and
providing updated tracking data from the tracking database to a user device of the first user.

12. The method of claim 11, wherein the publicly available data packet comprises an advertisement packet, the method further comprising:
determine, from the advertisement packet, that the third party tracking provider is associated with the third party tracking device.

13. The method of claim 12, wherein the API call request comprises data from the advertisement packet.

14. The method of claim 11, wherein the advertising packet includes a unique identifier.

15. The method of claim 14, wherein the third party tracking provider is determined from the unique identifier.

16. The method of claim 14, wherein the API call response comprises historical location data.

17. The method of claim 16, wherein the determining that the third party tracking device is associated with the first user is based on the historical location data.

18. The method of claim 17, wherein the historical location data comprises a plurality of locations that the third party tracking device is detected to be located within.

19. The method of claim 18, wherein the determining that the third party tracking device is associated with the first user comprises matching the plurality of locations to locations that the unique identifier is detected at.

20. The method of claim 19, wherein the tracking database stores historical tracking data associated with the unique identifier, and wherein the matching the plurality of locations to locations that the unique identifier is detected at comprises matching the historical location data to historical tracking data of the unique identifier.
